(19) United States
(12) Patent Application Publication
(10) Pub. No.: US 2006/0281847 A1
(43) Pub. Date: Dec. 14, 2006

(54) Fine particle liquid dispersion and recording medium using the same

(75) Inventors: Kanako Furutachi, Fukui-shi (JP); Kenichi Kawano, Fukui-shi (JP); Takahiro Tsutsui, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Finetech Inc., Mitsukaido-shi (JP)

(21) Appl. No.: 11/448,023

(22) Filed: Jun. 7, 2006

(30) Foreign Application Priority Data
Jun. 10, 2005 (JP) 2005-170689
Apr. 27, 2006 (JP) 2006-122987

(51) Int. Cl. C08K 3/22

(52) U.S. Cl. 524/430

(57) ABSTRACT

The invention provides a fine particle liquid dispersion in which inorganic fine particles are dispersed in an aqueous solvent, which further comprises at least one polymer selected from the group consisting of alkylamine-epihalohydrin copolymers, and dicyandiamide, allylamine and acrylic polymers, and acetic acid. The liquid dispersion is used to form an ink-receiving layer, thereby producing a recording medium.

### BACKGROUND OF THE INVENTION

1. Field of the Invention

The present invention relates to a fine particle liquid dispersion suitable for use in production of an ink-jet recording medium and a recording medium using this liquid dispersion, and particularly to a fine particle liquid dispersion, which is excellent in dispersiveness and shelf life and can form an ink-receiving layer excellent in transparency, smoothness and coating property, and a recording medium by which stimulative odor (unpleasant odor) emitted from its ink-receiving layer upon recording of an image and blurring of the image under high temperature and high humidity are suppressed.

2. Related Background Art

An ink-jet recording system is a system in which minute droplets of an ink are applied to a recording medium such as paper by any one of various working principles, and at the same time, a solvent component in the ink penetrates into the recording medium or evaporates, thereby precipitating a coloring material component in the ink on the recording medium to make recording of images, characters and/or the like (hereinafter referred to as “image” merely) and has such features that recording can be conducted at high speed and with a low noise, recording patterns are very flexible, multi-color images can be formed with ease, and development and image fixing are unnecessary. In recent years, in particular, ink-jet printers have been rapidly widespread as image-recording apparatus for various kinds of information instruments because an image formed by a multi-color ink-jet recording system has the merits that it is possible to obtain recording quality comparable with that of an image formed by multi-color, printing of a plate system, or a color photography system, and that it is possible to achieve a cheaper printing cost than that of the ordinary printing or photographic technique when the number of copies is small.

In order to improve recording properties such as speeding up and high definition of recording, and full-coloring of images, printing apparatus and printing methods have been improved, and printing media have also been required to have higher properties. More specifically, in order to obtain recorded images high in resolution and quality, which are comparable with a silver salt photograph, the recording media have been required to satisfy, for example, the following properties:

(1) providing printed dots high in density and vivid and bright in color tone;

(2) providing images high in contrast;

(3) having high ink absorbency so as for an ink not to run out or bleed in case printed dots overlap each other;

(4) preventing an ink from diffusing in a lateral direction beyond need to provide printed dots having a substantially round shape; and

(5) providing dots with smooth and clear peripheries.

In order to meet these requirements, some proposals have heretofore been made. For example, Japanese Patent Application Laid-Open No. 52-53012 discloses ink-jet recording paper of the plain paper type, in which a coating for surface processing is thinly applied on to a base paper web having a low sizing degree to improve the ink absorbency of the paper web, and Japanese Patent Application Laid-Open Nos. S55-51583 and S64-11877 disclose that non-crystalline silica is used as a pigment in a coating layer to improve the reproducibility of the shape, density or color tone of dots, which has been poor in the plain paper type described above. In recent years, recording media, in which a fine alumina hydrate is applied together with a water-soluble binder on to a substrate to improve the ink absorbency of the resulting ink-receiving layer, and the glossiness and transparency of an image to be formed, have been proposed, and are disclosed in, for example, Japanese Patent Application Laid-Open Nos. H02-276670, H07-76161 and H11-34486.

The alumina hydrate is said to be an ideal pigment because it has a positive charge, and the fixing ability of a dye in an ink is improved. In order to sufficiently utilize this merit for recording media, however, it is necessary to form an ink-receiving layer using a coating slip with the alumina hydrate retained in a good dispersed state. Therefore, an acid is generally added as a peptizing agent into an aqueous sol of the alumina hydrate. For example, Japanese Patent Application Laid-Open Nos. H04-67985 and H09-24666 each disclose a method for obtaining a transparent sol having good dispersibility by adding an organic acid such as acetic acid, formic acid or oxalic acid, or an inorganic acid such as nitric acid, hydrochloric acid or sulfuric acid.

On the other hand, recording media obtained by using a substrate having high surface smoothness, such as resin-coated paper or a film and forming an ink-receiving layer thereon are going to be mainly used for the purpose of achieving image glossiness comparable with that of a silver salt photograph. However, such a substrate is low in heat resistance and thus cannot be dried at a high temperature after the above-described alumina hydrate-containing coating slip is applied thereto, so that the acid that is a peptizing agent remains in the ink-receiving layer, which has formed the cause that unpleasant odor is emitted.

Any one of various kinds of surfactants or polymer dispersants is used as the peptizing agent in place of the acid to prepare a liquid dispersion, whereby the emission of such unpleasant odor may also be avoided. When a surfactant is used, however, bubbles are produced in the resulting liquid dispersion, and this forms the cause of a coating defect. When a polymer dispersant is used, relatively strong shearing force and stirring for a long period of time are required to peptize the alumina hydrate to primary particles, and it is thus difficult to provide a uniform liquid dispersion free of aggregate. Therefore, it has been impossible to stably form a high-quality ink-receiving layer. When a recording medium, on which an image has been formed, is exposed to a high-temperature and high-humidity environment, a dye migrates to blur the image, and so a method of adding a cationic resin into an ink-receiving layer to fix a coloring material has been generally taken. When the amount of the acid remaining in the ink-receiving layer is great, however, the effect of the cationic resin added is lowered, so that no satisfactory result may have been obtained in some cases.

### SUMMARY OF THE INVENTION

The present invention has been made in view of the foregoing circumstances and has as its object the provision of a fine particle liquid dispersion by which particle size and viscosity can be controlled within respective desired ranges under relatively mild stirring conditions and a high-quality ink-receiving layer can be stably formed.

Another object of the present invention is to provide a recording medium in which an ink-receiving layer is formed by using the above-described liquid dispersion, whereby stimulative odor (or unpleasant odor) emitted upon recording of an image is suppressed, and blurring of the image under high temperature and high humidity is effectively prevented.

The present inventors have carried out various investigations repeatedly with a view toward providing a fine particle liquid dispersion, which is excellent in dispersiveness and shelf life and can form an ink-receiving layer excellent in transparency, smoothness and coating property, and a recording medium in which stimulative odor (unpleasant odor) emitted upon recording of an image and blurring of the image under high temperature and high humidity are suppressed. As a result, it has been found that a specific polymer and a small amount of acetic acid are used upon the preparation of the fine particle liquid dispersion, whereby the above-described problems can be solved, thus leading to completion of the present invention.

According to the present invention, there is thus provided a fine particle liquid dispersion in which inorganic fine particles are dispersed in an aqueous solvent, which further comprises at least one polymer selected from the group consisting of alkylamine-epihalohydrin copolymers, and dicyandiamide, allylamine and acrylic polymers, and acetic acid.

In the fine particle liquid dispersion according to the present invention, the weight average molecular weight of the polymer may preferably be within a range of not lower than 1,000 and lower than 150,000.

In the fine particle liquid dispersion according to the present invention, it may be preferable that the inorganic fine particles be composed of alumina and/or alumina hydrate, and that the polymer be at least one polymer selected from the group consisting of polymers represented by the following general formulae (1) to (4) 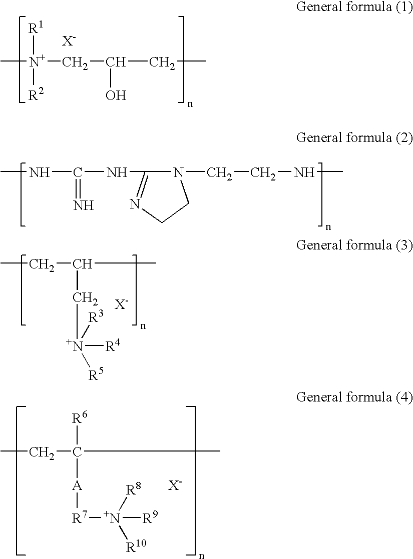
wherein R¹ and R² are, independently of each other, a hydrogen atom, an alkyl group having 1 to 18 carbon atoms or a benzyl group, R³, R⁴ and R⁵ are, independently of one another, a hydrogen atom, or an alkyl, alkenyl, alkanol, allylalkyl or allylalkenyl group which may be substituted, with the proviso that R¹ and R², and R³, R⁴ and R⁵ may be the same or different from one another, R⁶ is a hydrogen atom or a methyl group, R⁷ is a linear or branched alkylene group having 1 to 10 carbon atoms, R⁸ and R⁹ are, independently of each other, an alkyl group having 1 to 4 carbon atoms, R¹⁰ is an alkyl group, arylalkyl group or alicyclic alkyl group having 1 to 8 carbon atoms, A is —COO— or —CONH—, X⁻ is an inorganic or organic anion, and n is an integer indicating a degree of polymerization.

According to the present invention, there is also provided a recording medium comprising a substrate and an ink-receiving layer provided on at least one surface of the substrate, wherein the ink-receiving layer is formed with the above-described fine particle liquid dispersion according to the present invention.

The recording medium according to the present invention may preferably satisfy the relationships of the following formulae (1) to (3) at the same time.
1<ηA≦300 Formula (1)
ηA=ηC, and Formula (2)
CA<CC Formula (3)
wherein CA is the concentration (ppm) of acetic acid emitted in case an image is formed on the above-described ink-receiving layer, IA is the viscosity (mPa·s) of the fine particle liquid dispersion (A) used in the formation of the ink-receiving layer, ηC is the viscosity (mPa·s) of a fine particle liquid dispersion (C) prepared by using acetic acid without containing any polymer of alkylamine-epihalohydrin copolymers, and dicyandiamide, allylamine and acrylic polymers, and CC is the concentration (ppm) of acetic acid, which is emitted when the same image as described above is formed on an ink-receiving layer formed with the fine particle liquid dispersion (C).

According to the present invention, the above-described constitutions permit producing a fine particle liquid dispersion, which is excellent in dispersiveness and shelf life and can form an ink-receiving layer excellent in transparency, smoothness and coating property, and a recording medium by which stimulative odor (unpleasant odor) emitted upon recording of an image and blurring of the image under high temperature and high humidity are suppressed.

In other words, at least one polymer (hereinafter also referred to as “polymer represented by the general formula (1), (2), (3) or (4)”) selected from the group consisting of alkylamine-epihalohydrin copolymers, and dicyandiamide, allylamine and acrylic polymers, and acetic acid are used, whereby a fine particle liquid dispersion, by which particle size and viscosity can be controlled within respective desired ranges under relatively mild stirring conditions, can be provided, and the liquid dispersion is used to form an ink-receiving layer, whereby a recording medium, by which stimulative odor (unpleasant odor) emitted upon recording of an image is suppressed, and blurring of the image under high temperature and high humidity is effectively prevented, can also be provided.

### DETAILED DESCRIPTION OF THE PREFERRED EMBODIMENTS

The present invention will hereinafter be described in more detail by the best mode for carrying out the invention. The inorganic fine particles used in the present invention are preferably fine particles high in ink absorbing power, excellent in color developing property and capable of forming a high-quality image. Examples of such inorganic fine particles include calcium carbonate, magnesium carbonate, kaolin, clay, talc, hydrotalcite, aluminum silicate, calcium silicate, magnesium silicate, diatomaceous earth, alumina, colloidal alumina, aluminum hydroxide, alumina hydrate, synthetic amorphous silica, colloidal silica, lithopone and zeolite. These inorganic fine particles may be used either singly or in any combination thereof.

With respect to the form of the inorganic fine particles used in the present invention, the average particles size thereof is preferably within a range of from 100 nm to 500 nm, more preferably from 100 nm to 300 nm for providing an ink-receiving layer having high gloss and transparency. If the average particle size of the inorganic fine particles is smaller than 100 nm, the ink absorbency of an ink-receiving layer to be formed is markedly lowered to cause bleeding and beading of ink on the ink-receiving layer when printing is conducted by a printer great in ejected ink quantity. If the average particle size is greater than 500 nm on the other hand, the transparency of an ink-receiving layer to be formed is lowered, and the printing density and gloss of an image may be lowered in some cases when the image is formed on the ink-receiving layer. Incidentally, the average particle size as used herein may be measured by the dynamic light scattering method and determined by the analysis using the Cumulant method described in “Polymer Structure (2); Scattering Experiments and Morphological Observation; Chapter I: Light Scattering” (KYORITSU SHUPPAN, edited by The Society of Polymer Science, Japan), or J. Chem. Phys., 70(B), 15 Apl., 3965 (1979).

The BET specific surface area of the inorganic fine particles is preferably within a range of from 50 to 500 m²/g. If the BET specific surface area is smaller than 50 m²/g, the transparency of the resulting ink-receiving layer is impaired due to the large particle size thereof, the density of an image formed on the ink-receiving layer is lowered, and a print tends to become such an image as covered with a white mist. If the BET specific surface area exceeds 500 m²/g on the other hand, a great amount of an acid is required to peptize the fine particles. The BET specific surface area is more preferably within a range of from 50 to 250 m²/g because the ink absorbency, resistance to beading (a phenomenon that an ink cannot be absorbed to cause density unevenness in the form of beads) and smoothness of the resulting ink-receiving layer are more improved.

Incidentally, fine alumina particles such as alumina or alumina hydrate among the inorganic fine particles described above may preferably be used, and alumina hydrate having a boehmite structure or pseudoboehmite structure may more preferably be used in that an ink-receiving layer excellent in transparency and smoothness can be formed, and finer voids can be formed.

The inorganic fine particles used in the present invention may be easily peptized by using a great amount of an acid to provide a uniform liquid dispersion. Among acids generally known as peptizing agents, acetic acid may be said to be an ideal peptizing agent because it scarcely causes problems of chemical safety and corrosion and is relatively easy to handle. When the amount of acetic acid used is reduced for the purpose of decreasing the amount of acetic acid remaining in an ink-receiving layer to be formed to suppress acetic acid odor emitted upon recording of an image, however, the viscosity of the resulting liquid dispersion and the particle size of the inorganic fine particles in the liquid dispersion are increased. Therefore, at least one polymer selected from the group consisting of the polymers represented by the general formulae (1) to (4) and acetic acid are used in combination in the present invention to disperse and peptize the inorganic fine particles, thereby preparing a fine particle liquid dispersion. When at least one polymer selected from the group consisting of the polymers represented by the general formulae (1) to (4) is used in combination, whereby a fine particle liquid dispersion low in viscosity and excellent in dispersiveness and shelf life can be prepared even when the amount of acetic acid used is reduced.

The concentration of the inorganic fine particles in the liquid dispersion is preferably within a range of from 5 to 40% by mass, more preferably from 10 to 30% by mass. If the concentration of the inorganic fine particles is too low, the solid content of a coating slip finally prepared is reduced to worsen production efficiency because it takes lots of time and energy to dry the coating slip after coating. If the concentration of the inorganic fine particles is too high on the other hand, the viscosity of such a liquid dispersion becomes high to impose a burden on handling in subsequent steps. It is hence not preferable to use a liquid dispersion containing the inorganic fine particles at such a too low or too high concentration.

The amount of acetic acid used in the fine particle liquid dispersion according to the present invention varies according to the particle size and specific surface area of the inorganic fine particles used and may be such a minimum amount as to satisfactorily peptize the fine particles in the aqueous solvent. For the fine alumina particles, it is desirable that the amount of acetic acid is preferably less than 5.0% by mass and more preferably within a range of from 0.5 to 3.0% by mass. If the amount used is less than 0.1% by mass, the viscosity of the liquid dispersion may increase with time in some cases. Thus, such an amount is not preferable. If the amount used exceeds 10% by mass on the other hand, the dispersing effect does not increase beyond a certain degree, and problems of generation of characteristic odor of acetic acid and increase of energy required for drying arise in coating and drying processes.

The polymers used in the present invention and represented by the following general formulae (1) to (4) may be used either singly or in any combination thereof. 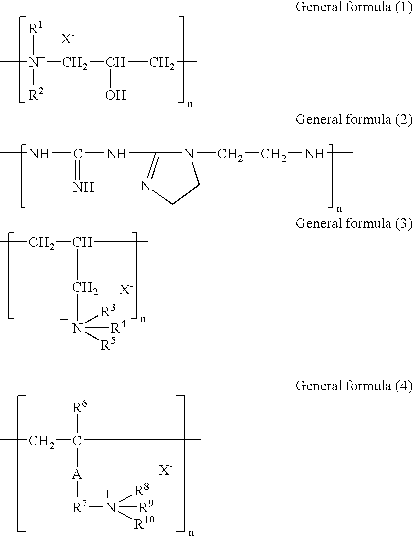
wherein R¹ and R² are, independently of each other, a hydrogen atom, an alkyl group having 1 to 18 carbon atoms, a benzyl group, or a primary or secondary alicyclic amine residue having a cyclohexane ring, R³, R⁴ and R⁵ are, independently of one another, a hydrogen atom, or an alkyl, alkenyl, alkanol, allylalkyl or allylalkenyl group which may be substituted, with the proviso that R¹ and R², and R³, R⁴ and R⁵ may be the same or different from one another, R⁶ is a hydrogen atom or a methyl group, R⁷ is a linear or branched alkylene group having 1 to 10 carbon atoms, R⁸ and R⁹ are, independently of each other, an alkyl group having 1 to 4 carbon atoms, R¹⁰ is an alkyl group, arylalkyl group or alicyclic alkyl group having 1 to 8 carbon atoms, A is —COO— or —CONH—, X⁻ is an inorganic or organic anion, and n is an integer indicating a degree of polymerization.

No particular limitation is imposed on the inorganic or organic anion. However, examples of the inorganic anion include Cl⁻, Br⁻, I⁻, nitrate ion, nitrite ion, phosphate ion and sulfate ion, and examples of the organic anion include sulfonate anion, alkylsulfonate anion and alkylcarboxylate anion, and besides anions derived from organic acids such as formic acid, acetic acid, glycolic acid, gluconic acid and lactic acid.

The weight average molecular weights of the polymers represented by the general formulae (1) to (4) are desirably be within a range of not lower than 1,000 and lower than 150,000, preferably from 1,000 to 60,000. If the weight average molecular weight is too low, bubbles are easily produced in the resulting fine particle liquid dispersion, and this may form the cause of a coating defect in some cases. If the weight average molecular weight is too high on the other hand, the viscosity of the resulting fine particle liquid dispersion becomes high, and so the dispersiveness thereof is deteriorated. It is hence not preferable to use a polymer having such a too low or high weight average molecular weight.

The amount of the polymers represented by the general formulae (1) to (4.) depends on the amount of acetic acid used in combination. However, such a polymer is preferably added in a small amount because the viscosities of the resulting fine particle liquid dispersion and a coating slip obtained by adding a binder to the liquid dispersion become high when the polymer is used in a great amount, and so the shelf life and coating suitability of the coating slip itself is deteriorated. Accordingly, the amount of the polymer used in the fine particle liquid dispersion according to the present invention is desirably within a range of preferably from 0.01 to 5% by mass, more preferably from 0.01 to 3% by mass for the alumina hydrate and less than the amount of acetic acid used. For example, the used mass ratio of the polymers represented by the general formulae (1) to (4) to acetic acid is preferably within a range of from 1:100 to 99:100, more preferably from 1:50 to 75:100.

An aqueous solvent in the fine particle liquid dispersion according to the present invention may be water or a mixed solvent of water and an organic solvent miscible with water. Examples of the organic solvent miscible with water include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

The fine particle liquid dispersion according to the present invention is obtained by dissolving at least one polymer selected from the group consisting of the polymers represented by the general formulae (1) to (4) and acetic acid in the above-described aqueous solvent and adding and dispersing the inorganic fine particles in the resultant solution. However, a preparation process of the liquid dispersion is not limited thereto. For example, a process, in which at least one polymer selected from the group consisting of the polymers represented by the general formulae (1) to (4), acetic acid and the inorganic fine particles are added at the same time to the aqueous solvent and dispersed therein; a process, in which at least one polymer selected from the group consisting of the polymers represented by the general formulae (1) to (4) is dissolved in the aqueous solvent, the inorganic fine particles are then added and dispersed in the resulting solution, and acetic acid is finally added; a process, in which acetic acid is dissolved in the aqueous solvent, the inorganic fine particles are then dispersed in the resultant solution, and at least one polymer selected from the group consisting of the polymers represented by the general formulae (1) to (4) is finally added to the resultant dispersion; or a process, in which the inorganic fine particles are dispersed in the aqueous solvent, and at least one polymer selected from the group consisting of the polymers represented by the general formulae (1) to (4) and acetic acid are then added, may be selected. A proper amount of at least one of at least one polymer selected from the group consisting of the polymers represented by the general formulae (1) to (4) and acetic acid is added to the aqueous solvent, the inorganic fine particles are dispersed in the resultant solution, at least one polymer selected from the group consisting of the polymers represented by the general formulae (1) to (4) and acetic acid are then additionally added, whereby the particle size and viscosity of the resulting fine particle liquid dispersion may be controlled to respective desired values.

As a method for dispersing the inorganic fine particles in the aqueous solvent or the aqueous solvent containing at least one polymer selected from the group consisting of the polymers represented by the general formulae (1) to (4) and/or acetic acid, any method of a continuous type and a batch type may also be used. As a dispersing machine, may be used any publicly known dispersing machine such as a high-pressure homogenizer, ultrasonic homogenizer, wet media type grinding machine (sand mill or ball mill), continuous high-speed stirring type dispersing machine or ultrasonic dispersing machine.

The viscosity of the fine particle liquid dispersion may be any viscosity so far as the shelf life of the liquid dispersion itself, and no burden is imposed on handling in subsequent steps. However, it is desirable that the viscosity is preferably 1 to 300 mPa·s, more preferably 1 to 100 mPa·s. Assuming that the viscosity of the fine particle liquid dispersion according to the present invention is ηA, and the viscosity of a fine particle liquid dispersion obtained by removing all the polymers of the alkylamine-epihalohydrin copolymers, and the dicyandiamide, allylamine and acrylic polymers from the fine particle liquid dispersion according to the present invention is ηC, the liquid dispersion according to the present invention satisfies preferably ηA<ηC, more preferably a range of (0.005×ηC)<ηA<ηC.

In the present invention, a recording medium can be obtained by forming an ink-receiving layer on a substrate using the fine particle liquid dispersion according to the present invention. Examples of the substrate include paper webs such as moderately sized paper, unsized paper, coat paper, cast-coated paper and resin-coated paper obtained by coating one or both surfaces of paper with a resin such as polyolefin; transparent thermoplastic resin films formed of polyethylene, polypropylene, polyester, poly(lactic acid), polystyrene, polyacetate, polyvinyl chloride, cellulose acetate, polyethylene terephthalate, polymethyl methacrylate, polycarbonate or the like; sheet-like materials (synthetic paper and the like) formed of a film opacified by filling an inorganic material or fine foaming; and sheets formed of glass or a metal. The surfaces of these substrates may also be subjected to a corona discharge treatment or various undercoating treatments for the purpose of improving adhesion strength between such a substrate and an ink-receiving layer.

Incidentally, in the present invention, a film and resin-coated paper having non-water-absorbing property and high smoothness is preferably used from the viewpoint of improving the glossiness of the ink-receiving layer formed on the substrate, and a substrate, in which at least a surface thereof to form an ink-receiving layer thereon has a 10-point average roughness of not greater than 0.5 μm as measured in accordance with JIS B 0601 and a 60°-specular gloss of 25 to 75% as measured in accordance with JIS Z 8741, may be more preferably used.

No particular limitation is imposed on the thickness of the substrate. However, the thickness is preferably within a range of from 25 to 500 μm, more preferably from 50 to 300 μm. If the thickness of the substrate is smaller than 25 μm, the stiffness of the substrate becomes low, and a feeling and texture when touched with a hand, or the opacity thereof is insufficient, so that inconveniences are caused. If the thickness is greater than 500 μm on the other hand, the resulting recording medium becomes rigid, and such a recording medium may interfere with its traveling in a printer in some cases. No particular limitation is also imposed on the weight of the substrate. However, the weight is preferably within a range of about 25 to 500 g/m².

A binder such as a water-soluble resin and/or a water-dispersible resin is used together with the fine particle liquid dispersion according to the present invention for a coating slip prepared for forming an ink-receiving layer upon production of a recording medium according to the present invention. Examples of the water-soluble resin and/or the water-dispersible resin used in the present invention include starch, gelatin and casein and modified products thereof, cellulose derivatives such as methyl cellulose, carboxymethyl cellulose, hydroxyethyl cellulose, completely or partially saponified polyvinyl alcohol and modified products (such as cationically modified products, anionically modified products and silanol-modified products) thereof, urea resins, melamine resins, epoxy resins, epichlorohydrin resins, polyurethane resins, polyethylene-imine resins, polyamide resins, polyvinyl pyrrolidone resins, polyvinyl butyral resins, poly(meth)acrylic acid and copolymers thereof, acrylamide resins, maleic anhydride copolymers, polyester resins, SBR latexes, NBR latexes, methyl methacrylate-butadiene copolymer latexes, latexes of acrylic polymers such as acrylic ester copolymers, latexes of vinyl polymers such as ethylene-vinyl acetate copolymers, and functional group-modified polymer latexes with a cationic group or anionic group added to these various polymer latexes. Among these, polyvinyl alcohol obtained by hydrolyzing polyvinyl acetate and having an average polymerization degree of 300 to 5,000 is preferred. The saponification degree thereof is preferably not lower than 70% and lower than 100%, more preferably from 80 to 99.5%. These water-soluble or water-dispersible resins may be used either singly or in any combination thereof.

The amount of the binder (B) used is preferably such that the mixing mass ratio (B)/(A) of the binder (B) to the inorganic fine particles (A) is within a range of from 1/30 to 1/1, more preferably from 1/20 to 1/3. When the amount of the binder falls within this range, an ink-receiving layer to be formed is hard to cause cracking and powdery coming-off and also has good ink absorbency. No particular limitation is imposed on a method for mixing the fine particle liquid dispersion with the binder. However, a method, in which the water-soluble or water-dispersible resin is dissolved in a necessary amount of an aqueous medium in advance, and this solution is mixed with the fine particle liquid dispersion, is preferred. The mixing may be conducted by any system of a batch system and a continuous system.

No particular limitation is imposed on the aqueous medium so far as it is water or a mixed solvent of water and an organic solvent miscible with water. Examples of the organic solvent miscible with water include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

In order to improve the film-forming ability, water resistance and film strength of a coating film formed by the inorganic fine particles and the water-soluble resin and/or the water-dispersible resin in the recording medium according to the present invention, a hardener may also be added into the ink-receiving layer. The hardener is generally selected from various substances according to the kind of a reactive group possessed by a polymer used. For example, when the polymer used is a polyvinyl alcohol resin, epoxy hardeners, and inorganic hardeners such as boric acid and water-soluble aluminum salts may be mentioned as the hardener. Boron compounds such as oxygen acids having a boron atom in their centers or salts thereof, specifically, orthoboric acid, metaboric acid, hypoboric acid, tetraboric acid, pentaboric acid and salts thereof may preferably be used.

The amount of the boron compound used varies according to the amount of the water-soluble resin and/or the water-dispersible resin used as a binder. However, the boron compound may be generally added in a proportion of 0.1 to 30% by mass based on the water-soluble resin and/or the water-dispersible resin. If the content of the boron compound is lower than 0.1% by mass based on the water-soluble resin and/or the water-dispersible resin, the film-forming ability is lowered to fail to impart sufficient water resistance to the ink-receiving layer formed. If the content exceeds 30% by mass on the other hand, change of the viscosity of the coating slip with time becomes great, and so coating stability may be lowered in some cases.

Examples of a method for adding the hardener to the ink-receiving layer include a method, in which the hardener is directly added to a coating slip containing the fine particle liquid dispersion and the binder, and the resultant mixture is applied by a batch system, a method, in which the hardener is added into the fine particle liquid dispersion in advance, and the resultant mixture is applied while being continuously mixed with the binder right before coating, a method, in which the hardener is dissolved in another aqueous medium in advance, and the resultant solution is in-line added into a coating slip containing the fine particle liquid dispersion and the binder right before coating, and a method, in which a solution containing the hardener is applied before or after coating of a coating slip containing the fine particle liquid dispersion and the binder. In any method, a coating slip for forming the ink-receiving layer may be prepared batch-wise or continuously to form the ink-receiving layer. Any of these methods may be used.

No particular limitation is imposed on the solid content of the coating slip for forming the ink-receiving layer so far as the coating slip has such a viscosity that the ink-receiving layer can be formed on the substrate. However, the solid content is preferably 5 to 50% by mass based on the whole mass of the coating slip. If the solid content is lower than 5% by mass, it is required to increase the coating weight for thickening the thickness of the ink-receiving layer. In this case, drying requires lots of time and energy, so that such a coating slip may not be economical in some cases. If the solid content exceeds 50% by mass on the other hand, the viscosity of the coating slip becomes high, so that the coating ability of the coating slip may be lowered in some cases.

Various kinds of additives may be incorporated into the coating slip within limits not impeding the effect of the present invention. As examples of such additives, may be mentioned antifoaming agents, ink-fixing agents, dot adjusters, colorants, fluorescent whitening agents, preservatives, pH adjusters, antistatic agents, conductivity-imparting agents, ultraviolet absorbents and antioxidants (anti-fading agents).

As a process for coating the substrate with the thus-prepared coating slip, may be used any conventionally known coating process such as a spin coating, roll coating, blade coating, air-knife coating, gate roll coating, bar coating, size pressing, spray coating, gravure coating, curtain coating, rod blade coating, lip coating or slit die coating process. Thereafter, drying is conducted by means of a drying device such as a hot air dryer, heated drum or far infrared dryer, whereby the ink-receiving layer can be formed. Incidentally, the ink-receiving layer in the recording medium according to the present invention may be formed into multi-layers by changing the compositional ratio of the inorganic fine particles to the binder and other additives, and may also be formed on one surface or both surfaces of the substrate. The surface smoothness of the ink-receiving layer may also be improved by means of a calender roll or the like after the coating.

A preferable range of the coating weight of the coating slip on the substrate is from 0.5 to 60 g/m² in terms of solid content, and a more preferable range of the coating weight is from 5 to 55 g/m². If the coating weight is less than 0.5 g/M2, the formed ink-receiving layer cannot sufficiently absorb water in ink, and so in some cases, the ink may run, or an image formed may blur. If the coating weight exceeds 60 g/m² on the other hand, curling may occur on the resulting recording medium upon drying, or such a marked effect as expected may not be developed on printing performance.

For the thus-obtained recording medium according to the present invention, the amount of acetic acid added can be reduced to a low extent compared with the case where a fine particle liquid dispersion containing none of the polymers represented by the general formulae (1) to (4) and having the same viscosity as that of the fine particle dispersion according to the present invention is used, so that the concentration of acetic acid emitted when an image is formed on the ink-receiving layer can be effectively suppressed. In other words, assuming that the concentration of acetic acid emitted when an image is formed on the recording medium according to the present invention is CA (ppm), and the concentration of acetic acid emitted when the same image as described above is formed on an ink-receiving layer formed with a fine particle liquid dispersion prepared without containing any of the polymers represented by the general formulae (1) to (4) and having the same viscosity as that of the fine particle dispersion according to the present invention is CC (ppm), the concentration of acetic acid emitted when an image is formed on the ink-receiving layer preferably satisfies CA<CC. A range of CA<0.5×CC is more preferred because acetic acid odor is more suppressed. Incidentally, the concentration of acetic acid as used herein means a concentration of acetic acid emitted to a fixed volume from an ink-receiving layer having a fixed coating weight when an image is formed on the ink-receiving layer and the recording medium is then left at rest at 23° C. for 10 minutes. The fine particle liquid dispersion containing none of the polymers represented by the general formulae (1) to (4) and having the same viscosity as that of the fine particle dispersion according to the present invention means a liquid dispersion whose viscosity difference from that of the fine particle liquid dispersion according to the present invention is within ±5%.

The concentration of acetic acid remaining in the ink-receiving layer may be reduced by using a high temperature set in a drying process or controlling the drying time when the heat resistance of a substrate is low. When a limitation is imposed on a space to place a dryer upon continuous drying after the coating and drying cannot be sufficiently conducted, it is advantageous that a recording medium is produced with the fine particle liquid dispersion according to the present invention.

Incidentally, no particular limitation is imposed on inks used in recording on the recording medium according to the present invention. However, general ink-jet recording water-based inks obtained by using a dye or pigment as a coloring material, using a mixture of water and a water-soluble organic solvent as a medium and dissolving or dispersing the dye or pigment in the medium are preferably used.

As a process for applying the inks to the recording medium to form an image, is particularly preferred an ink-jet recording process. As the ink-jet recording process, any process may be used so far as it is a process capable of effectively ejecting an ink from a nozzle to apply the ink to a recording medium. In particular, an ink-jet system described in Japanese Patent Application Laid-Open No. S54-59936, in which an ink undergoes a rapid volumetric change by the action of thermal energy applied to the ink, so that the ink is ejected from a nozzle by the working force generated by this change of state, may be used effectively.

The present invention will hereinafter be described specifically by the following Examples. Incidentally, all designations of “part” or “parts” and “%” as will be used in the following examples mean part or parts by weight and % by weight unless expressly noted.

<Preparation of Alumina Hydrate>

Aluminum dodecanoxide was prepared in accordance with the process described in U.S. Pat. No. 4,242,271. The aluminum dodecanoxide was then hydrolyzed in accordance with the process described in U.S. Pat. No. 4,202,870 to prepare an alumina slurry. Water was added to the alumina slurry until the solid content of alumina hydrate reached 7.7%. The slurry was aged in an autoclave under such conditions that the aging temperature was 150° C., and the aging time was 6 hours, thereby obtaining a colloidal sol. This colloidal sol was spray-dried at an inlet temperature of 87° C. to prepare alumina hydrate powder. The particle shape of the resultant powder was in a flat-plate form. The measurement by X-ray diffraction revealed that the crystal structure of the alumina hydrate is a boehmite structure. The BET specific surface area of the resultant powder was measured by means of a specific surface area and pore distribution measuring device (Micromeritex ASAP2400, manufactured by Shimadzu Corporation) and was found to be 140.5 m²/g.

### EXAMPLE 1

To 100 parts of ion-exchanged water, were added 0.065 part (0.1% based on the alumina hydrate) of PAA-HCl-05 (40% aqueous solution, weight average molecular weight: about 5,000, product of Nitto Boseki Co., Ltd.) as an allylamine polymer and 4.35 parts (1% based on the alumina hydrate) of a 6% aqueous solution of acetic acid. The resultant mixture was stirred for 10 minutes at 150 rpm by means of a three-one motor (BL600, rating torque: 5 kgf·cm, agitating element: turbine type, manufactured by Shinto Scientific Co., Ltd.) to prepare a dispersion solvent. Thereafter, 26.1 parts of the alumina hydrate was added while controlling the temperature of the dispersion solvent to 25° C. in a low-temperature constant-temperature water bath, and the number of revolutions of the three-one motor was then controlled to 350 rpm to stir the resultant mixture for 10 minutes, thereby obtaining an alumina liquid dispersion having an alumina hydrate solid content of 20% with respect to the whole liquid dispersion. The tests of the following Evaluations 1 and 2 were made as to the thus-obtained alumina liquid dispersion with the following points in mind.

<Evaluation 1: Viscosity of Alumina Liquid Dispersion>

The alumina liquid dispersion was left at rest for 15 minutes in a low and constant temperature water bath set at 25° C., and its viscosity was then measured by means of a Brookfield type viscometer (BM model, manufactured by Tokyo Keiki Co., Ltd.).

<Evaluation 2: Particle Size of Fine Alumina Particles>

The average particle size of the fine alumina particles in the alumina liquid dispersion was measured by means of a laser particle size analysis system, PAR III (manufactured by Otsuka Electronics Co., Ltd.).

### EXAMPLE 2

An alumina liquid dispersion was prepared in the same manner as in EXAMPLE 1 except that the amounts of the allylamine polymer and the aqueous solution of acetic acid in EXAMPLE 1 were changed to 0.653 part (1% based on the alumina hydrate) and 8.70 parts (2% based on the alumina hydrate), respectively, and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 3

An alumina liquid dispersion was prepared in the same manner as in EXAMPLE 1 except that the allylamine polymer in EXAMPLE 1 was changed to 0.621 part (1% based on the alumina hydrate) of PAA-HCl-01 (42.0% aqueous solution, weight average molecular weight: about 1,000, product of Nitto Boseki Co., Ltd.), the amount of the aqueous solution of acetic acid was changed to 8.70 parts (2% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 4

An alumina liquid dispersion was prepared in the same manner as in EXAMPLE 1 except that the allylamine polymer in EXAMPLE 1 was changed to 0.104 part (0.1% based on the alumina hydrate) of PAA-CH₃COOH-L (25.0% aqueous solution, weight average molecular weight: about 15,000, product of Nitto Boseki Co., Ltd.), the amount of the aqueous solution of acetic acid was changed to 5.44 parts (1.25% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 5

An alumina liquid dispersion was prepared in the same manner as in EXAMPLE 1 except that the allylamine polymer in EXAMPLE 1 was changed to 0.131 part (0.1% based on the alumina hydrate) of PAA-H-HCl (20.0% aqueous solution, weight average molecular weight: about 60,000, product of Nitto Boseki Co., Ltd.), the amount of the aqueous solution of acetic acid was changed to 5.44 parts (1.25% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 6

An alumina liquid dispersion was prepared in the same manner as in EXAMPLE 1 except that the allylamine polymer in EXAMPLE 1 was changed to 0.499 part (1% based on the alumina hydrate) of an experimental product (in the general formula (1), R¹=R²=CH₃, X⁻=Cl⁻, 52.3% aqueous solution, molecular weight: 6,000, product of Dai-ichi Kogyo Seiyaku Co., Ltd.) that is an alkylamine-epihalohydrin copolymer, the amount of the aqueous solution of acetic acid was changed to 8.70 parts (2% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 7

An alumina liquid dispersion was prepared in the same manner as in EXAMPLE 1 except that the allylamine polymer in EXAMPLE 1 was changed to 0.384 part (1% based on the alumina hydrate) of PALSET JK-230 (68.0% aqueous solution, molecular weight: 3,000 to 5,000, product of Meisei Chemical Works, Ltd.) as a dicyandiamide polymer, the amount of the aqueous solution of acetic acid was changed to 8.70 parts (2% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### EXAMPLE 8

An alumina liquid dispersion was prepared in the same manner as in EXAMPLE 1 except that the allylamine polymer in EXAMPLE 1 was changed to 0.028 part (0.1% based on the alumina hydrate) of SHALLOL DM-283P (91.6% white granulated powder, molecular weight: about 28,000, product of Dai-ichi Kogyo Seiyaku Co., Ltd.) as an acrylic polymer, the amount of the aqueous solution of acetic acid was changed to 5.44 parts (1.25% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1.

### COMPARATIVE EXAMPLES 1 to 3

Alumina liquid dispersions were prepared in the same manner as in EXAMPLE 1 except that the allylamine polymer in EXAMPLE 1 was not used, the amount of the aqueous solution of acetic acid was controlled to 4.35 parts, 5.44 parts and 8.70 parts (1%, 1.25% and 2% based on the alumina hydrate), and the amount of the ion-exchanged water was controlled in such a manner that the solid content of the alumina hydrate in the whole alumina liquid dispersion was 20%, and the tests of Evaluations 1 and 2 were made. The results are shown in Table 1. Incidentally, the alumina liquid dispersions, in which the amount of acetic acid added was controlled to 1% and 1.25% based on the alumina hydrate, were high in viscosity, so that considerably strong stirring was required when boric acid and polyvinyl alcohol were added thereto to prepare coating slips.

### COMPARATIVE EXAMPLE 4

An alumina liquid dispersion was prepared in the same manner as in EXAMPLE 1 except that the aqueous solution of acetic acid in EXAMPLE 1 was not used, and the amount of the ion-exchanged water was controlled in such a manner that the solid content of the alumina hydrate in the whole alumina liquid dispersion was 20%, and the tests of Evaluations 1 and 2 were made. However, a great amount of aggregate occurred, so that the test of Evaluation 2 could not be carried out.

### COMPARATIVE EXAMPLE 5

An alumina liquid dispersion was prepared in the same manner as in EXAMPLE 2 except that the aqueous solution of acetic acid in EXAMPLE 2 was not added, and the amount of the ion-exchanged water was controlled in such a manner that the solid content of the alumina hydrate in the whole alumina liquid dispersion was 20%. However, the liquid dispersion began to separate into 2 layers in about 15 minutes after the preparation, so that the test of Evaluation 1 was not carried out. Since a great amount of aggregate occurred, the test of Evaluation 2 could not be carried out.

### COMPARATIVE EXAMPLE 6

An alumina liquid dispersion was prepared in the same manner as in EXAMPLE 4 except that the aqueous solution of acetic acid in EXAMPLE 4 was not used, and the amount of the ion-exchanged water was controlled in such a manner that the solid content of the alumina hydrate in the whole alumina liquid dispersion was 20%, and the tests of Evaluations 1 and 2 were made. However, a great amount of aggregate occurred, so that the test of Evaluation 2 could not be carried out.

### COMPARATIVE EXAMPLE 7

An alumina liquid dispersion was prepared in the same manner as in EXAMPLE 6 except that the aqueous solution of acetic acid in EXAMPLE 6 was not added, and the amount of the ion-exchanged water was controlled in such a manner that the solid content of the alumina hydrate in the whole alumina liquid dispersion was 20%. However, the liquid dispersion began to separate into 2 layers in about 15 minutes after the preparation, so that the test of Evaluation 1 was not carried out. Since a great amount of aggregate occurred, the test of Evaluation 2 could not be carried out.

### COMPARATIVE EXAMPLE 8

An alumina liquid dispersion was prepared in the same manner as in EXAMPLE 7 except that the aqueous solution of acetic acid in EXAMPLE 7 was not added, and the amount of the ion-exchanged water was controlled in such a manner that the solid content of the alumina hydrate in the whole alumina liquid dispersion was 20%. However, the liquid dispersion began to separate into 2 layers in about 15 minutes after the preparation, so that the test of Evaluation 1 was not carried out. Since a great amount of aggregate occurred, the test of Evaluation 2 could not be carried out.

### COMPARATIVE EXAMPLE 9

An alumina liquid dispersion was prepared in the same manner as in EXAMPLE 8 except that the aqueous solution of acetic acid in EXAMPLE 8 was not used, and the amount of the ion-exchanged water was controlled in such a manner that the solid content of the alumina hydrate in the whole alumina liquid dispersion was 20%, and the test of Evaluation 1 was made. A great amount of aggregate occurred, so that the test of Evaluation 2 could not be carried out.

TABLE 1

| | | Amount of | | |
|---|---|---|---|---|
| | Amount of | acetic acid | | |
| | polymer added (*1) | added (*2) | Evaluation 1 | Evaluation 2 |
| EX. 1 | 0.1 | 1.0 | 27.1 | 189.5 |
| EX. 2 | 1.0 | 2.0 | 9.4 | 174.7 |
| EX. 3 | 1.0 | 2.0 | 8.9 | 173.5 |
| EX. 4 | 0.1 | 1.25 | 134.5 | 176.4 |
| EX. 5 | 0.1 | 1.25 | 228.5 | 177.0 |
| EX. 6 | 1.0 | 2.0 | 10.0 | 175.2 |
| EX. 7 | 1.0 | 2.0 | 9.6 | 174.0 |
| EX. 8 | 0.1 | 1.25 | 280.0 | 178.6 |
| COMP. | Not added | 1.0 | 1,320.0 | 195.1 |
| EX. 1 | | | | |
| COMP. | Not added | 1.25 | 942.0 | 182.6 |
| EX. 2 | | | | |
| COMP. | Not added | 2.0 | 28.2 | 172.9 |
| EX. 3 | | | | |
| COMP. | 0.1 | Not added | 1,230.0 | Immeasurable |
| EX. 4 | | | | |
| COMP. | 1.0 | Not added | Separated | Immeasurable |
| EX. 5 | | | | |
| COMP. | 0.1 | Not added | 642.0 | Immeasurable |
| EX. 6 | | | | |
| COMP. | 1.0 | Not added | Separated | Immeasurable |
| EX. 7 | | | | |
| COMP. | 1.0 | Not added | Separated | Immeasurable |
| EX. 8 | | | | |
| COMP. | 0.1 | Not added | 242.0 | Immeasurable |
| EX. 9 | | | | |

(*1): % by mass of a polymer selected from the group consisting of alkylamine-epihalohydrin copolymers, and dicyandiamide, allylamine and acrylic polymers based on the fine alumina particles.
(*2): % by mass based on the fine alumina particles.
Evaluation 1: Viscosity (mPa · s) of the alumina liquid dispersion.
Evaluation 2: Average particle size (nm) of the fine alumina particles

As apparent from Table 1, it is understood that when the amounts of acetic acid added are the same, the alumina liquid dispersions according to the present invention, which were prepared by using at least one polymer selected from the group consisting of alkylamine-epihalohydrin copolymers, and dicyandiamide, allylamine and acrylic polymers, and acetic acid, have a viscosity lower than that of any liquid dispersion containing no polymer (from the comparison of EXAMPLE 1 with COMPARATIVE EXAMPLE 1, the comparison of EXAMPLES 2, 3, 6 and 7 with COMPARATIVE EXAMPLE 3, and the comparison of EXAMPLES 4, 5 and 8 with COMPARATIVE EXAMPLE 2). It is also understood that in a range (particularly, a range of not greater than 1.25% by mass) where the amount of acetic acid added was small, the alumina liquid dispersions according to the present invention have a smaller average particle size, and the fine alumina particles are efficiently peptized (from the comparison of EXAMPLE 1 with COMPARATIVE EXAMPLE 1, and the comparison of EXAMPLES 4, 5 and 8 with COMPARATIVE EXAMPLE 2). Incidentally, the alumina liquid dispersions (COMPARATIVE EXAMPLES 4 to 9) prepared by using at least one polymer selected from the group consisting of alkylamine-epihalohydrin copolymers, and dicyandiamide, allylamine and acrylic polymers without acetic acid contained a great amount of aggregate, and the particles could not be peptized under the same stirring conditions.

### EXAMPLE 9

Into 100 parts of the alumina liquid dispersion prepared in EXAMPLE 1, was mixed 10.0 parts (15% based on polyvinyl alcohol) of a 3% aqueous solution of boric acid, and 20.0 parts (10% based on the alumina hydrate) of a solution prepared by dissolving 5 parts of polyvinyl alcohol (PVA-224, product of Kuraray Co., Ltd.) in 45 parts of ion-exchanged water was added thereto to prepare a coating slip. Polyethylene-coated paper (thickness: 224 μm, basis weight: 234 g/m², 60°-specular gloss: 64% as measured in accordance with JIS Z 8741; product of Oji Paper Co., Ltd., custom-made product) was used as a substrate, and the previously prepared coating slip was applied on to the paper by means of a wire bar so as to give a dry coating weight of 35 g/m², followed by drying for 20 minutes at 110° C by a blast constant-temperature dryer (FC-610, manufactured by Toyo Engineering Works, Ltd.) to produce a recording medium. The resultant recording medium was subjected to the following Evaluations 3 and 4. The results are shown in Table 2.

<Evaluation 3: Concentration of Acetic Acid Emitted from a Recording Medium Printed>

After an A4-sized (210×297 mm) recording medium was left to stand for 12 hours at 23° C. and 50% RH, and printing of a mixed black color was conducted on the whole surface of the ink-receiving layer of the recording medium by means of an ink-jet printer (BJ F900, manufactured by Canon Inc.) in accordance with the following method. This print was put into a closable container (internal volume: 4 L) equipped with a rubber tube as a gas detection tube within 10 seconds after completion of the printing and hermetically kept therein in such a manner that the printed surface does not come into contact with an inner wall of the container. After 10 minutes, the concentration of acetic acid was measured by means of an acetic acid detection tube (No. 81L, manufactured by Gastec Corporation) to correct the read numerical value in terms of temperature (standard: 20° C.) and atmospheric pressure (standard: 1,013 hPa).

<Preparation Method of Printed Image for Measurement of Acetic Acid Concentration>

A graphic preparation tool (Photoshop Version 4.0, product of Adobe Systems Incorporated) was used to prepare a TIFF type image under the following conditions.

Image size: 210×297 mm

Image mode: RGB color (8 bits/channel)

Solid printing: black (R=0, G=0, B=0).

<Printing Method>

Printing was conducted on the whole surface without changing the standard setting except that the following settings were changed in the property window of the printer.

Basic setting: Kind of paper . . . Prophoto Paper

Printing quality . . . beautiful
Color adjustment . . . manual adjustment
Matching method . . . for graphics
   Page setting: Paper size . . . A4 (210×297 mm)
Kind of printing . . . trim-free whole surface printing
Sticking-out quantity . . . maximum.
   <Evaluation 4: Evaluation Method as to Image Blurring (Migration Resistance) Under High Humidity>

Recording media, on which solid printing (ink quantity: 100%) had been conducted with each single color of black (Bk), cyan (C), magenta (M) and yellow (Y) inks by means of an ink-jet recording apparatus (BJ F870, manufactured by Canon Inc.), were exposed to an environment of 30° C. and 80% RH for one week to visually rank the degree of blurring of the images. The recording media were ranked as “A” where no blurring occurred in each of the colors, “B” where blurring slightly occurred in any of the colors, or “C” where blurring greatly occurred in any of the colors.

### EXAMPLES 10 to 12

A recording medium was produced in the same manner as in EXAMPLE 9 except that the alumina liquid dispersion used in EXAMPLE 9 was changed to the alumina liquid dispersions prepared in EXAMPLE 2, EXAMPLE 6 and EXAMPLE 7, and the tests of Evaluations 3 and. 4 were made. The results are shown in Table 2.

### EXAMPLE 13

An alumina liquid dispersion (X) was prepared in the same manner as in EXAMPLE 4 except that the amounts of the allylamine polymer and the aqueous solution of acetic acid in EXAMPLE 4 were changed to 1.044 parts (1% based on the alumina hydrate) and 13.05 parts (3% based on the alumina hydrate), respectively, and the amount of the ion-exchanged water was controlled in such a manner that the solid content of the alumina hydrate in the whole alumina liquid dispersion was 20%, and the test of Evaluation 1 was made. A recording medium was produced in the same manner as in EXAMPLE 9 except that the alumina liquid dispersion used in EXAMPLE 9 was changed to the alumina liquid dispersion (X), and the tests of Evaluations 3 and 4 were made. The results are shown in Table 2.

### COMPARATIVE EXAMPLE 10

A recording medium was produced in the same manner as in EXAMPLE 9 except that the alumina liquid dispersion used in EXAMPLE 9 was changed to the alumina liquid dispersion prepared in COMPARATIVE EXAMPLE 3, and the tests of Evaluations 3 and 4 were made. The results are shown in Table 2.

### COMPARATIVE EXAMPLE 11

An alumina liquid dispersion (Y) was prepared in the same manner as in EXAMPLE 1 except that the allylamine polymer in EXAMPLE 1 was not used, the amount of the aqueous solution of acetic acid was changed to 21.75 parts (5% based on the alumina hydrate), and the amount of the ion-exchanged water was controlled in such a manner that the solid content of the alumina hydrate in the whole alumina liquid dispersion was 20%, and the test of Evaluation 1 was made. A recording medium was produced in the same manner as in EXAMPLE 9 except that the alumina liquid dispersion used in EXAMPLE 9 was changed to the alumina liquid dispersion (Y), and the tests of Evaluations 3 and 4 were made. The results are shown in Table 2.

### COMPARATIVE EXAMPLE 12

Into 100 parts of an alumina liquid dispersion. (Y) prepared in the same manner as in COMPARATIVE EXAMPLE 11, were mixed 10.0 parts (15% based on polyvinyl alcohol) of a 3% aqueous solution of boric acid and 0.653 part (1% based on the alumina hydrate) of PAA-HCl-05 (40% aqueous solution of an allylamine polymer, weight average molecular weight: about 5,000, product of Nitto Boseki Co., Ltd.), and 20.0 parts (10% based on the alumina hydrate) of a solution prepared by dissolving 5 parts of polyvinyl alcohol (PVA-224, product of Kuraray Co., Ltd.) in 45 parts of ion-exchanged water was added thereto to prepare a coating slip (A). A recording medium was then produced in the same manner as in EXAMPLE 9 except that the coating slip used in EXAMPLE 9 was changed to the coating slip (A), and the tests of Evaluations 3 and 4 were made. The results are shown in Table 2.

### COMPARATIVE EXAMPLE 13

A coating slip (B) was prepared in the same manner as in COMPARATIVE EXAMPLE 12 except that the allylamine polymer in COMPARATIVE EXAMPLE 12 was changed to 1.044 parts (1% based on the alumina hydrate) of PAA-CH₃COOH-L (25.0% aqueous solution, weight average molecular weight: about 15,000, product of Nitto Boseki Co., Ltd.). A recording medium was then produced in the same manner as in EXAMPLE 9 except that the coating slip used in EXAMPLE 9 was changed to the coating slip (B), and the tests of Evaluations 3 and 4 were made. The results are shown in Table 2.

TABLE 2

| | | | Amount of | | | |
|---|---|---|---|---|---|---|
| | | | polymer | | | |
| | Amount added to alumina | | added to | | | |
| | liquid dispersion | | coating | Evaluation | | |
| | Polymer (*1) | Acetic acid (*2) | slip (*1) | 1 | 3 | 4 |
| EX. 9 | 0.1 | 1.0 | Not added | 27.1 | 0.2 | A |
| EX. | 1.0 | 2.0 | Not added | 9.4 | 0.9 | A |
| 10 | | | | | | |
| EX. | 1.0 | 2.0 | Not added | 10.0 | 1.0 | A |
| 11 | | | | | | |
| EX. | 1.0 | 2.0 | Not added | 9.6 | 1.0 | A |
| 12 | | | | | | |
| EX. | 1.0 | 3.0 | Not added | 10.2 | 1.8 | A |
| 13 | | | | | | |
| COMP. | Not added | 2.0 | Not added | 28.2 | 1.0 | B |
| EX. | | | | | | |
| 10 | | | | | | |
| COMP. | Not added | 5.0 | Not added | 9.8 | 3.3 | C |
| EX. | | | | | | |
| 11 | | | | | | |
| COMP. | Not added | 5.0 | 1.0 | 9.8 | 3.3 | C |
| EX. | | | | | | |
| 12 | | | | | | |
| COMP. | Not added | 5.0 | 1.0 | 9.8 | 3.4 | C |
| EX. | | | | | | |
| 13 | | | | | | |

(*1) % by mass of a polymer selected from the group consisting of alkylamine-epihalohydrin copolymers, and dicyandiamide, allylamine and acrylic polymers based on the fine alumina particles.
(*2) % by mass based on the fine alumina particles.
Evaluation 1: Viscosity (mPa · s) of the alumina liquid dispersion.
Evaluation 3: Concentration (ppm) of acetic acid.
Evaluation 4: Migration resistance.

As apparent from Table 2, it is understood that when the viscosities of the alumina liquid dispersions are the same, the recording media produced by using the alumina liquid dispersions according to the present invention are lower in the concentration of acetic acid emitted when an image is formed on their ink-receiving layers than the concentration of acetic acid emitted when an image is formed on the ink-receiving layer formed with the alumina liquid dispersion containing none of the alkylamine-epihalohydrin copolymers, and the dicyandiamide, allylamine and acrylic polymers, and so the acetic acid odor thereof is suppressed upon the printing (from the comparison of EXAMPLE 9 with COMPARATIVE EXAMPLE 10 and the comparison of EXAMPLES 10 to 13 with COMPARATIVE EXAMPLE 11). It is also understood that when the viscosities of the alumina liquid dispersions are the same, the recording media produced by using the alumina liquid dispersions according to the present invention exhibit far excellent properties in image blurring under high humidity compared with the recording media produced by using the alumina liquid dispersions containing none of the above-described polymers (from the comparison of EXAMPLE 9 with COMPARATIVE EXAMPLE 10 and the comparison of EXAMPLES 10 to 13 with COMPARATIVE EXAMPLE 11). It is further understood that image blurring of the recording media produced by using the alumina liquid dispersions according to the present invention is more suppressed under high humidity than that of the recording media which are produced by using the alumina liquid dispersions containing none of the above-described polymers, give a great amount of acetic acid remaining in their ink-receiving layers (great in the amount of acetic acid emitted upon printing), and contain the polymers in an amount equivalent to that of the recording media according to the present invention in their ink-receiving layers (from the comparison of EXAMPLE 10 with COMPARATIVE EXAMPLE 12 and the comparison of EXAMPLE 13 with COMPARATIVE EXAMPLE 13).

According to the present invention, fine particle liquid dispersions, by which particle size and viscosity can be controlled within respective desired ranges under relatively mild stirring conditions, could be provided by using at least one polymer selected from the group consisting of the alkylamine-epihalohydrin copolymers, and the dicyandiamide, allylamine and acrylic polymers, and acetic acid. Such a liquid dispersion is used to form an ink-receiving layer, whereby recording media, by which stimulative odor (or unpleasant odor) emitted upon recording of an image and blurring of the image under high temperature and high humidity are suppressed, could be prevented.

While the invention has been described with reference to the preferred embodiments disclosed herein, it is not confined to the details set forth and this application is intended to cover such modifications or changes as may come within the purpose of the improvements or the scope of the appended claims.

This application claims priority benefits of Japanese Patent Applications No. 2005-170689 filed Jun. 10, 2005 and No. 2006-122987 filed Apr. 27, 2006 the entire disclosures of which are incorporated herein by reference in their entirety.

What is claimed is:

1. A fine particle liquid dispersion in which inorganic fine particles are dispersed in an aqueous solvent, which further comprises at least one polymer selected from the group consisting of alkylamine-epihalohydrin copolymers, and dicyandiamide, allylamine and acrylic polymers; and acetic acid.

2. The fine particle liquid dispersion according to claim 1, wherein of the polymer has a weight average molecular weight within a range of not lower than 1,000 and lower than 150,000.

3. The fine particle liquid dispersion according to claim 1, wherein the inorganic fine particles are composed of at least one of alumina and alumina hydrate.

4. The fine particle liquid dispersion according to claim 1, wherein the polymer is at least one polymer selected from the group consisting of polymers represented by the following general formulae (1) to (4): 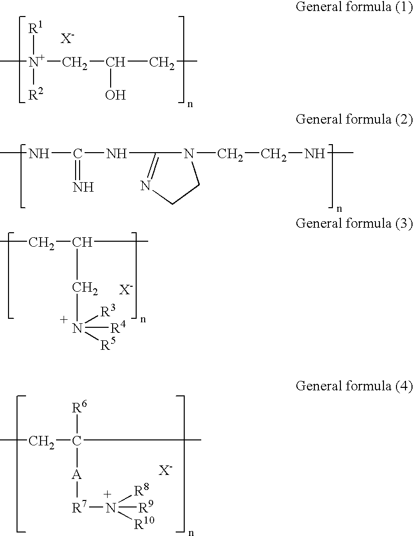
wherein R¹ and R² are, independently of each other, a hydrogen atom, an alkyl group having 1 to 18 carbon atoms or a benzyl group, R³, R⁴ and R⁵ are, independently of one another, a hydrogen atom, or an alkyl, alkenyl, alkanol, allylalkyl or allylalkenyl group which may be substituted, with the proviso that R¹ and R², and R³, R⁴ and R⁵ may be the same or different from one another, R⁶ is a hydrogen atom or a methyl group, R⁷ is a linear or branched alkylene group having 1 to 10 carbon atoms, R⁸ and R⁹ are, independently of each other, an alkyl group having 1 to 4 carbon atoms, R¹⁰ is an alkyl group, arylalkyl group or alicyclic alkyl group having 1 to 8 carbon atoms, A is —COO— or —CONH—, X⁻ is an inorganic or organic anion, and n is an integer indicating a degree of polymerization.

5. A recording medium comprising a substrate and an ink-receiving layer provided on at least one surface of the substrate, wherein the ink-receiving layer is formed using the fine particle liquid dispersion according to claim 1.

6. The recording medium according to claim 5, which satisfies the relationships of the following formulae (1) to (3) at the same time
1<ηA≦300 Formula (1)
ηA=ηC, and Formula (2)
CA<CC Formula (3)
wherein CA is the concentration (ppm) of acetic acid emitted in case an image is formed on the ink-receiving layer, ηA is a viscosity (mPa·s) of the fine particle liquid dispersion (A) used in the formation of the ink-receiving layer, ηC is the viscosity (mPa·s) of a fine particle liquid dispersion (C) prepared by using acetic acid without containing any polymer of alkylamine-epihalohydrin copolymers, and dicyandiamide, allylamine and acrylic polymers, and CC is the concentration (ppm) of acetic acid, which is emitted when the same image as described above is formed on an ink-receiving layer formed with the fine particle liquid dispersion (C).
